(19) United States
(12) Patent Application Publication
(10) Pub. No.: US 2026/0139441 A1
(43) Pub. Date: May 21, 2026

(54) A TOOL FOR THERMOFORMING A WET-MOLDED FIBER PRODUCT

(71) Applicant: Additive Innovation and Manufacturing Sweden AB, Frösön (SE)

(72) Inventors: Axel BERGSTRÖM, Frösön (SE); Stefan THUNDAL, Göteborg (SE)

(21) Appl. No.: 18/881,713

(22) PCT Filed: Jun. 22, 2023
(86) PCT No.: PCT/EP2023/066992

§ 371 Date: Jan. 6, 2025

(30) Foreign Application Priority Data
Jul. 8, 2022 (SE) 2250878-2
Dec. 6, 2022 (SE) 2251424-4

(51) Int. Cl. D21J 3/00; B33Y 10/00

(52) U.S. Cl. CPC D21J 3/00; B33Y 10/00

(57) ABSTRACT

A tool for thermoforming a wet-molded fiber product and an apparatus for thermoforming a wet-molded fiber product comprising said tool. The tool includes a base member, and a reception member including an upper surface for receiving the wet-molded fiber product and a lower surface. The upper surface of the reception member has a complementary shape to the wet-molded fiber product. The reception member is arranged to drain a fluid from a received wet-molded fiber product. The tool further includes a support structure providing a distance between a surface of the base member and the lower surface of the reception member. The support structure is configured so that a heat transfer from the base member to the reception member through the support structure is controlled in a direction along the upper surface of the reception member.

### TECHNICAL FIELD

The present disclosure relates generally to the production of wet-molded fiber products such as packaging products, coffee cups, lids, plates, food trays. In particular, the present disclosure relates to a pressing tool for thermoforming such products. The present disclosure also relates to an apparatus for thermoforming a wet-molded fiber product comprising said pressing tool.

### BACKGROUND

There is a strong trend to replace single-use plastic products such as coffee cups, lids, plates, food trays etc. with other more sustainable products. One of the most promising alternatives to single-use plastic products are products made of formed natural/cellulose fibers (i.e., paper). Such products are often referred to as wet-molded fiber (molded fiber, molded pulp, or formed fiber) products. There are several different types of molded fiber manufacturing processes. The most common manufacturing process for the products mentioned above is fiber thermoforming.

In thermoforming, wet-molded fiber products are formed by submerging a forming tool into a cellulose slurry (also called stock) and applying a vacuum on the backside of the forming tool. The forming tool is permeable to air and water. The vacuum drains water through a porous tool surface, which allows cellulose fibers to be collected on the tool surface.

In one or more proceeding pressing steps, remaining water/steam is drained from the partly formed fibers by applying heat through pressing tools, which provides the final shape of the paper product. Thus, a dry and strong paper product is formed after the pressing steps. The forming tool roughly forms the products, whereas the pressing tools form the product more precisely and therefore plays as larger role for the product quality and productivity of the manufacturing process.

The wet-molded fiber product is commonly transferred from the forming tool to a pressing tool by a transfer tool, and thereafter between different pressing tools by the same or by another transfer tool. Typically, an array of tools is used in each step. For example, an array of 28 forming tools may be used in the forming step, and respective arrays of 28 pressing tools may be used in the pressing steps.

In one pressing step, the wet-molded fiber product is typically pressed between two pressing tools with corresponding shapes to the wet-molded fiber products. Here, one or both of these pressing tools have a surface that is permeable to steam and water. Such surface is normally a porous surface and/or a perforated surface, i.e., comprising a plurality of holes. Remaining water/steam in the wet-molded fiber product is drained through the surface by pressing the pressing tools together and by heating the pressing tools. In other words, the wet-molded fiber product is dried in the pressing steps. Different pressing tools may be used in each of the pressing steps to provide different pressing and drying properties.

There is a continuous need for improving pressing tools for speeding up the production cycle in the manufacturing of wet-molded fiber products.

### SUMMARY

It is an object of the present disclosure to provide improved tools for thermoforming a wet-molded fiber product, and in particular to provide improved pressing tool for pressing steps in the thermoforming. This object is at least in part achieved by a tool for thermoforming a wet-molded fiber product. The tool comprises a base member, and a reception member comprising an upper surface for receiving the wet-molded fiber product and a lower surface. The upper surface of the reception member has a complementary shape to the wet-molded fiber product. The reception member is arranged to drain a fluid from a received wet-molded fiber product. The tool further comprises a support structure providing a distance between a surface of the base member and the lower surface of the reception member. The support structure is configured so that a heat transfer from the base member to the reception member through the support structure is controlled in a direction along the upper surface of the reception member.

The disclosed tool provides high heat transfer capabilities, i.e., being able to transfer heat from a heat source to a received wet-molded fiber product via the base member, support structure, and reception member, while also providing good draining properties, i.e., being able to drain fluid (e.g., air, water, or steam) from the received wet-molded fiber product via the reception member. Normally, steam is evacuated from the received wet-molded fiber product when using the disclosed tool. When using the disclosed tool, the received wet-molded fiber product is dried. The disclosed tool enables the wet-molded fiber product to be dried quicker in the pressing steps compared to conventional pressing tools. This means that the overall cycle time in production of the wet-molded product may be reduced, which is highly desired.

The control of the heat transfer by the support structure enables a desired heat pattern on the upper surface of the reception member. In other words, the heat transfer is controlled over the upper surface of the reception member. For example, if the base member faces a source of heat (e.g., via a lower surface of the base member), such as a heat plate, the heat may propagate unevenly through the base member towards the surface of the base member facing the reception member. The varying heat transfer of the support structure may be used to compensate for the heat transfer characteristics of the base member such that a desired heat pattern is obtained on the upper surface of the reception member. In some cases, a uniform heat pattern is desired on the upper surface of the reception member. In other cases, hotter areas on the upper surface of the reception member may be desired, e.g., if the wet-molded product comprises a thicker portion in those areas. If the heating pattern of the reception member is not controlled, there may be areas with burnt paper and areas with insufficient drying, which is highly undesired. Burnt areas and areas with insufficient drying are particularly problematic in a quick drying process using large amounts of heat. The control of the heat transfer by the support structure in the disclosed tool thus enables a quicker drying of the wet-molded fiber product compared to conventional pressing tools.

According to aspects, the support structure is configured to conduct heat from the base member to the reception member. In that case, the support structure is in thermal contact with the base member and with the reception member, respectively.

According to some aspects, the reception member is provided with a plurality of through holes between the upper surface and the lower surface. In other words, at least a portion of the upper surface of the reception member is perforated. The though holes are arranged to evacuate a fluid, such as steam, from a received wet-molded product. In other words, the through holes are arranged to drain a fluid from a received wet-molded fiber product. The through holes provides good draining properties while being easy to manufacture.

According to some aspects, at least a portion of the reception member is porous. The porous portion is arranged to evacuate a fluid, such as steam, from a received wet-molded product. In other words, the porous is arranged to drain a fluid from a received wet-molded fiber product. The porous surface may e.g. be manufactured using additive manufacturing. In that case, good draining properties are obtained at a reasonable manufacturing complexity. The reception member may comprise both a porous portion and through holes, arranged separately or in combination.

According to some aspects, the support structure is arranged in a non-uniform pattern in a direction along the lower surface of the reception member. This provides a way of controlling the heat transfer from the base member to the reception member. If the support structure comprises a plurality of support elements (such as pillars/cylinders), these support elements may have different shapes and/or dimensions, where the shapes and/or dimensions vary for different support elements along the lower surface of the reception member. Alternatively, or in combination of, such support elements may have different thermal conductivities. Furthermore, the amount of support elements per area may vary along the lower surface of the reception member.

According to some aspects, the base member is provided with a first portion configured to interface a source of heat. According to some other aspects, the tool further comprises a backing member provided with a second portion configured to interface a source of heat, wherein the base member is provided with a recess in which the backing member is received. The recess reduces manufacturing time, particularly in additive manufacturing processes. The recess may be arranged on the lower surface of the base member.

According to some aspects, the support structure is arranged to form one or more cavities between the reception member and the base member. If the reception member comprises through holes or a porous portion, the through holes or porous portion of the reception member are connected to the one or more cavities such that fluid (such as water and/or steam) may be drained from the wet-molded product into the one or more cavities via the through holes or porous portion. This provides good draining properties of the tool.

According to some aspects, the support structure comprises one or more guiding walls arranged to conduct heat from the base member to the reception member. Alternatively, or in combination of, the support structure comprises a plurality of pillars arranged to conduct heat from the base member to the reception member. Such support structures are easy to manufacture, supports the reception member well on the base member, and are easy to arrange to such that the first and/or second contact surface is arranged in a non-uniform pattern so that the heat transfer through the support structure varies along the lower surface of the reception member. The plurality of pillars in particular enables high heat transfer capabilities and good draining properties of the tool.

According to some aspects, a number of pillars per area vary in a direction along the lower surface of the reception member. Similarly, each pillar in the plurality of pillars may be associated with a cross section, wherein respective cross sections of at least some of the pillars vary in a direction along the lower surface of the reception member. By controlling the dimension (e.g., cross section) and placement of each pillar, the conduction of heat to the reception member form the base member may be controlled. Thicker dimensions of pillars spaced closely together will increase the heat transfer rate (i.e., increase conductivity of a corresponding portion of the support structure) while smaller dimensions of pillars spaced further apart will reduce the heat transfer rate.

According to some aspects, the base member, the reception member, and the support structure are monolithically formed. This provides good heat transfer properties of the tool. Such tool is also easy to manufacture, using e.g. an additive manufacturing process such as three-dimensional (3D) printing. According to some other aspects, the reception member and the support structure are monolithically formed, and the support structure is attached to base member. This way, only the reception member and the support structure may be manufactured using an additive manufacturing process, and the base member may be manufactured in other ways, e.g. using milling or casting. The reception member and the support structure are normally relative complex compared to the base member. Therefore, an additive manufacturing process may be the most efficient manufacturing process in terms of e.g. cost. Other manufacturing processes such as milling may be more suitable for the base member, which has relatively low complexity.

According to some aspects, the support structure comprises one or more paths configured to evacuate a fluid when the wet-molded fiber product is received on the tool. This provides good draining properties of the tool.

According to some aspects, the surface of the base member is provided with at least one through hole configured to evacuate a fluid when the wet-molded fiber product is received on the tool. This further improves draining properties. This at least one through hole may extend through the optional backing member discussed above. Steam may be drained from the wet-molded fiber product into the reception member, and thereafter be evacuated into the support structure, and finally into the at least one through hole of the base member.

According to some aspects, any of the reception member, the support structure, and the base member are manufactured by an additive manufacturing process. This provides a cost-effective way of manufacturing the tool.

There is also disclosed herein, an apparatus for thermoforming a wet-molded fiber product, which is associated with the above-discussed advantages. The apparatus comprises a first tool and a second tool according to the discussions above, where the tools are configured to sandwich the wet-molded fiber product between the tools. The apparatus further comprises means for bringing the first tool against the second tool, and a source of heat arranged to heat the first tool and/or the second tool.

There is also disclosed herein, a method for producing a tool according to the discussions above using an additive manufacturing process. The method comprises the steps of forming the reception member, forming the support structure on the reception member, and forming the base member on the support structure.

There is also disclosed herein control units, computer programs, computer readable media, computer program products, associated with the above-discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present disclosure will become apparent when studying the appended claims and the following description. The skilled person realizes that different features of the present disclosure may be combined to create embodiments other than those described in the following, without departing from the scope of the present disclosure.

### BRIEF DESCRIPTION OF THE DRAWINGS

With reference to the appended drawings, below follows a more detailed description of embodiments of the present disclosure cited as examples. In the drawings:

FIGS. 1 and 2 are schematic illustrations of respective tools;

FIG. 3 shows an example tool;

FIGS. 4 and 5 show different views of a cut from the tool in FIG. 3;

FIG. 6 is a schematic illustration of a tool;

FIG. 7 shows a cut of an example tool;

FIG. 8 is a schematic illustration of two tools;

FIG. 9 is a flow chart illustrating a method;

FIG. 10 schematically illustrates a control unit;

FIG. 11 schematically illustrates a portion of a support structure; and

FIG. 12 schematically illustrates a portion of a support structure.

### DETAILED DESCRIPTION

The present disclosure is described more fully below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

As mentioned, there is need for improved pressing tools. In conventional pressing tools, there is normally a tradeoff between heat transfer properties and draining properties. For example, solid tools with a metal mesh, i.e., a perforated surface, provide low heat transfer but have good draining properties. Solid tools without a mesh, on the other hand, provide high heat transfer but have poor draining properties.

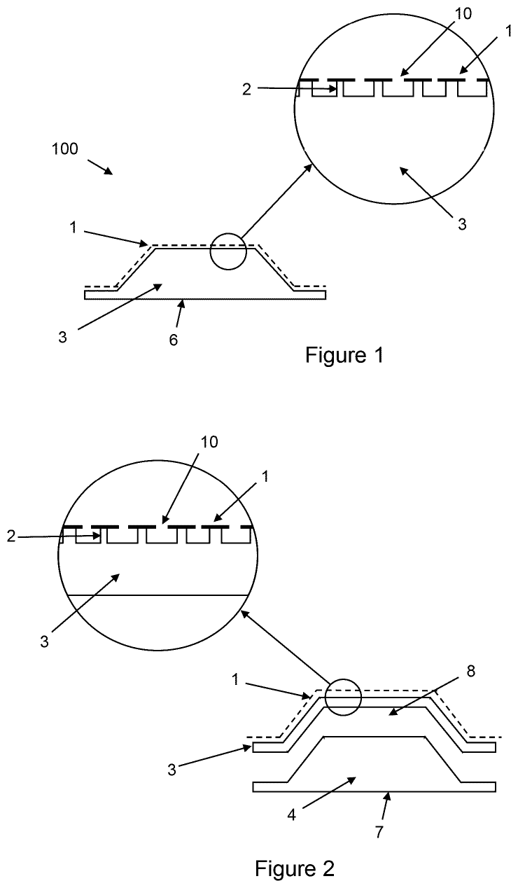

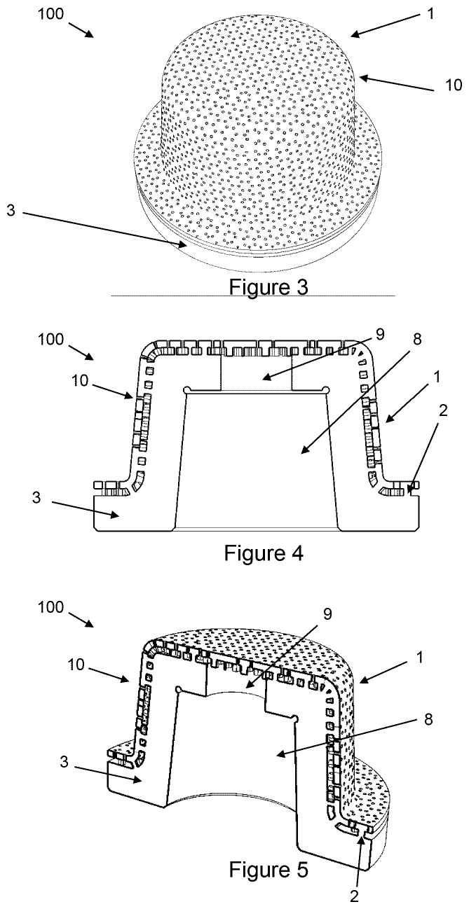

The tool 100, 101 disclosed herein presents both high heat transfer and good draining properties. FIGS. 1, 2, 6, and 8 show schematic illustrations of examples tools 100, 101, and FIGS. 3-5 and 7 show different views of an example tool 100. The tool may be a pressing tool and is suitable for thermoforming a wet-molded fiber product. The disclosed tool may also be used for other purposes.

The tool may be a female version or a male version where the two versions are configured to sandwich a wet-molded fiber product between them. Examples of a female version 101 and a male version 100 of the disclosed tool are shown in FIG. 8. In this figure, the wet-molded fiber product is received between respective reception members 1, which are perforated by a large number of small holes 10. Here, large may mean more than 50. The holes are small relative to the total area of the surface of the reception member that receives the wet-molded fiber product. The holes are through holes and extend through the reception member. Alternatively, or in combination, at least a portion of the reception member may be porous. The porous portion also provides draining properties. In the tools 100 and 101, the respective reception members are arranged at respective distances from respective base members 3 by respective support structures (not shown in FIG. 8). The reception member may also be called a thin-walled pulp-facing skin. Here, thin-walled means that a thickness of the reception member is small relative to a thickness of a base member 3. The base member 3 may also be called a back wall or supporting back wall. Furthermore, the tool may be arranged in array for pressing a plurality of products simultaneously.

In FIG. 8, heat may be provided by one or more heat sources to the male and/or the female version of the tool.

When the wet-molded fiber product is sandwiched between two tools, both of them are not necessarily tools according to the present disclosure; one of them may be a conventional tool, e.g. a solid tool without a mesh.

To summarize, the disclosed tool 100, 101 comprises a base member 3, and a reception member 1 comprising an upper surface for receiving the wet-molded fiber product and a lower surface. The upper surface of the reception member has a complementary shape to the wet-molded fiber product. The reception member is arranged to drain a fluid from a received wet-molded fiber product. Thus, at least a portion of the reception member is permeable to gases and liquid. The portion is particularly permeable to steam and water. The tool further comprises a support structure 2 providing a distance between a surface of the base member 3 and the lower surface of the reception member 1.

The surface of the base member may be called an upper surface of the base member. The base member also has a lower surface. The lower surface of the base member may be arranged on an opposite side of the base member compared to the upper surface. Herein, the term “upper surface” does not mean that the surface must face upwards. The surface may face other orientations as well. The term “lower” in “lower surface” relates the lower surface to the upper surface, and does not restrict the “lower surface” to any particular orientation. The lower surface and the upper surface of the base member may also be called a first surface and a second surface of the base member, respectively. The lower surface and the upper surface of the reception member may also be called a first surface and a second surface of the reception member, respectively.

The complementary shape of the reception member 1 of the tool 100, 101 means that the shape corresponds to the shape of the wet-molded fiber product. Here, the wet-molded fiber product is normally an at least partially formed paper product. The tool has a shape such that a desired shape of the product may be formed when using the tool. Since the product may be formed in several steps by different pressing tools, each tool in the different steps may have a shape that looks more and more like the final product as the steps progresses.

The base member 3 typically constitute the largest portion of the tool 100, 101, e.g., in terms of mass and/or volume. As mentioned, the reception member 1 has a complementary shape to the wet-molded fiber product. Normally, the surface of the base member 3 facing the reception member also has a complementary shape to the wet-molded fiber product.

The lower surface of the reception member 1 is typically arranged at constant distance from the surface of the base member 3 facing the reception member. However, the distant may be non-constant along the lower surface of the reception member 1. The support structure 2 is arranged to provide the distance and to connect the base member to the reception member.

The reception member 1 may be provided with a plurality of through holes 10 between the upper surface and the lower surface. In other words, at least a portion of the upper surface of the reception member is perforated. The though holes are arranged to evacuate a fluid, such as steam, from a received wet-molded product. In other words, the through holes are arranged to drain a fluid from a received wet-molded fiber product. The through holes provides good draining properties while being easy to manufacture.

The through holes 10 may be discretely designed and positioned over the surface of the reception member 1, e.g., in a three-dimensional (3D) computer aided design (CAD) model. All through holes may have the same cross section, such as the circular cross section shown in FIGS. 3-5. However, the through holes may have other shapes as well, such as rectangular. Furthermore, different through holes may have different shapes and sizes. The through holes may be distributed uniformly or non-uniformly on the reception member 1. By controlling the shape, size, number, placement etc. of the through holes, it is possible to control draining properties of the tool 100, 101.

At least a portion of the reception member 1 may be porous. Herein, a porous material comprises a solid matrix and a pore space (also called pore network). The solid matrix and a pore space may be continuous and interpenetrated, such as in a sponge. The porous portion can also be called a sponge-like portion. The porous portion is arranged to evacuate a fluid, such as steam, from a received wet-molded product. In other words, the porous is arranged to drain a fluid from a received wet-molded fiber product. The porous surface may e.g. be manufactured using additive manufacturing. In that case, good draining properties are obtained at a reasonable manufacturing complexity. The reception member may comprise both a porous portion and through holes, arranged separately or in combination. Furthermore, the whole reception member may be porous.

The porous portion may e.g. be generated stochastically using an additive manufacturing process. As an example, additive manufacturing may provide a porous surface that is 2 mm thick and has a porosity of 30%.

The example tool 100 of FIGS. 3-5 is arranged to form a paper cup of 50 mm in diameter. In this example tool, the reception member 1 has a thickness of 2 mm and is arranged a distance of 2 mm from the base member 3. The through holes 10 have a diameter of 0.5 mm.

The support structure 2 is configured so that a heat transfer from the base member 3 to the reception member 1 through the support structure is controlled in a direction along the upper surface of the reception member. Furthermore, at least a part of the support structure 2 may be configured to conduct heat from the base member 3 to the reception member 1. In that case, the support structure is in thermal contact with the base member and the reception member, respectively. Alternatively, or in combination, at least a part support structure may be configured to thermally isolate heat transfer from the base member 3 to the reception member 1. According to aspects, the support structure 2 is configured so that a heat transfer from the base member 3 to the reception member 1 through the support structure varies in a direction along the upper surface of the reception member. According to other aspects, varying the heat transfer means to vary a heat transfer rate. According to additional aspects, controlling the heat transfer means to control a heat transfer rate.

The support structure may be arranged in a non-uniform pattern in a direction along the lower surface of the reception member. This provides a way of controlling the heat transfer from the base member to the reception member.

The support structure 2 may comprise one or more support elements, such as a plurality of pillars, one or more guiding walls, and/or a plurality of hexagonal prisms forming a honeycomb pattern. If the support structure comprises a plurality of support elements, these support elements may have different shapes and/or dimensions, where the shapes and/or dimensions vary for different support elements along the lower surface of the reception member. Furthermore, the support elements may be arranged in a non-periodic or quasi-periodic pattern in two dimensions. Herein, a quasi-periodic pattern is interpreted to mean a pattern that is locally periodic but displays no long-range order. Alternatively, or in combination of, the support elements may have different thermal conductivities, where the thermal conductivity vary for different support elements along the lower surface of the reception member. Different thermal conductivity may be obtained from different materials. Alternatively, support elements of the same material may have different thermal conductivities arising from different internal structures. For example, one support element may be uniform and another support element may comprise a plurality of cavities (e.g., air bubbles). In other words, different support elements may have different porosities. In any case, the support elements may be arranged such that the heat transfer of the support structure varies in a direction along the lower surface of the reception member.

The support structure may contact the base member by a first total contact surface and may contact the reception member by a second total contact surface. If, e.g., the support structure comprises a plurality of support elements (such as pillars), the first total contact surface is the sum of all cross sections of the support elements in a plane along the surface of the base member facing the reception member and the second total contact surface is the sum of all cross sections of the support elements in a plane along the lower surface of the reception member. The support elements may have different shapes of the cross sections of the part contacting the base member, where the shapes vary for different support elements along the surface of the base member facing the reception member. Similarly, the support elements may have different shapes of the cross sections of the part contacting the reception member, where the shapes vary for different support elements along the lower surface of the reception member. The variation of cross sections is an example of arranging the support elements in a non-uniform pattern so that a heat transfer of the support structure is controlled in a direction along the upper surface of the reception member.

In an example, the base member and the reception member are respective flat uniform rectangles. If heat is applied uniformly to a lower surface of the base member, which is opposite the surface of the base member facing the reception member (i.e. and upper surface of the base member), the upper surface of the reception member may have a non-uniform heat pattern due to the arrangement of the support structure. Here, the support structure is configured so that the heat transfer from the base member to the reception member through the support structure is controlled to obtain said heat pattern.

The support structure 2 may also be arranged to form one or more cavities between the reception member 1 and the base member 3. If the reception member comprises through holes or a porous portion, the through holes 10 or porous portion of the reception member are connected to the one or more cavities such that fluid (such as water and/or steam) may be drained from the wet-molded product into the one or more cavities via the through holes 10 or porous portion. If, e.g., the support structure comprises a plurality of support elements, such as pillars, a single cavity may be formed between the pillars (and reception member and base member). Furthermore, as is illustrated in the example tool of FIG. 7, the support structure 2 may comprise one or more paths configured to evacuate a fluid when the wet-molded fiber product is received on the tool. If, e.g., the support structure comprises a plurality of support elements, such as pillars, the space between the pillars may constitute such paths. If the support structure comprises one or more guiding walls (which is discussed in more detail below), such walls may comprise through holes that forms said paths. In FIG. 7, the arrows 11 show different evacuation paths for draining a fluid from the wet-molded fiber product. In particular, the arrows 11 show that fluid may be evacuated via a through hole 9 of the base member 3 and via an end of the support structure.

In order to maximize productivity, there typically needs to be a balance between applied heat and draining capabilities for evacuating fluid. If too much heat is used the paper product will be burnt. Furthermore, the reception member 1 normally should be uniformly heated regardless of the geometry of the tool for maximum productivity.

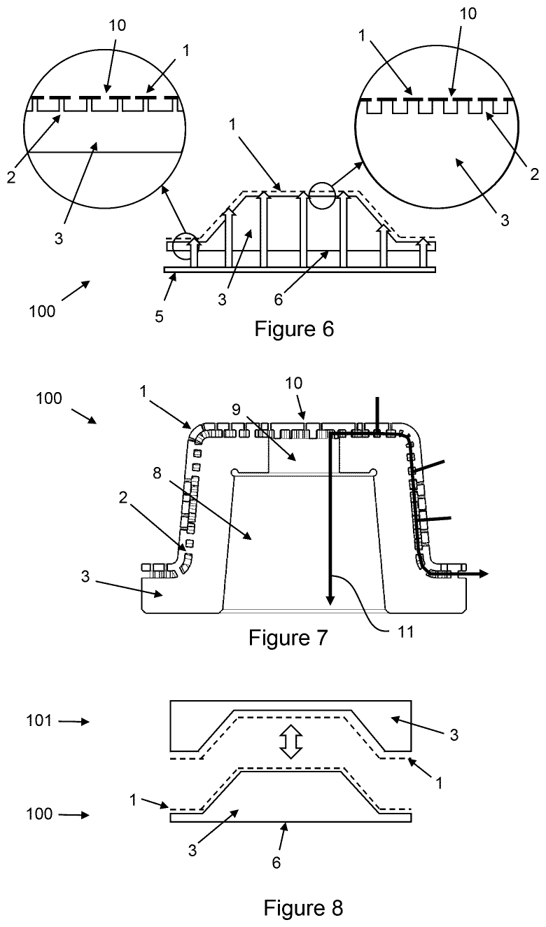

The varying heat transfer of the support structure 2 enables a desired heat pattern on the reception member 1. For example, if the base member 3 faces a source of heat 5, such as a heat plate, the heat may propagate unevenly through the base member towards the reception member. FIG. 6 shows an example of a base member interfacing a heat source 5. Heat propagating through the base member is represented by wide arrows.

The base member may be heated in other ways. For example, one or more heating elements may be extending into the base member. In that case, the heating elements may be arranged in holes drilled on the base member. In other words, the base member 3 is provided with integrated heating elements. In another example, the base member is heated through inductive heating. The varying heat transfer of the support structure 2 may be used to compensate for the heat transfer characteristics of the base member 3 such that a desired heat pattern is obtained on the surface of the reception member 1. As mentioned, a uniform heat pattern is normally desired on the reception member. However, hotter areas on the reception member may be desired in some cases, e.g., if the wet-molded product comprises a thicker portion in those areas. If the heating pattern of the reception member is not controlled, there may be areas with burnt paper and areas with insufficient drying, which is highly undesired.

The support structure 2 may comprise a plurality of pillars arranged to conduct heat from the base member 3 to the reception member 1. In the example tools of FIGS. 1-7, the thin-walled pulp-facing skin is supported on its backside by a gallery of pillars 2 (i.e., a plurality of pillars), which creates a cavity between the thin-walled pulp-facing skin and the base member 3. A pillar may also be called a post and is a structure used to support the reception member on the base member. In the examples tools of FIGS. 1-7, the pillars are respective cylinders with one end of each cylinder constitute part of the first contact surface and the other end constitute part of the second contact surface. The pillars may have other shapes well. For example, the pillar may have square cross sections and may be non-uniform in their extension directions. Furthermore, the cross section of one end of a pillar may be different from the cross section of the other end of that pillar. In the example tool of FIGS. 3-5, the cylindrical pillar have a diameter of 2 mm and an extension length of 2 mm.

By controlling the dimension (e.g., cross section) and placement of each pillar, the conduction of heat to the pulp-facing skin may be controlled. Thick dimensions of pillars spaced closely together will increase the heat transfer rate (i.e., increase conductivity of a corresponding portion of the support structure) while smaller dimensions of pillars spaced further apart will reduce the heat transfer rate. In other words, a number of pillars 2 per area vary in a direction along the lower surface of the reception member 1. Furthermore, each pillar in the plurality of pillars may be associated with a cross section, wherein respective cross sections of at least some of the pillars vary in a direction along the lower surface of the reception member 1. The cross section is measured perpendicular to an extension direction of a pillar. The cross section may also be called thickness. Varying any of the pillar density and the cross sections is a way of controlling the heat transfer from the base member to the reception member through the support structure is a direction along the upper surface of the reception member.

One possible way of arranging the pillars is to vary the number of pillars per area in a direction along the lower surface of the reception member 1 as a function of a distance between a pillar and the surface of the base member facing a heat source. In other words, the farther a pillar is from the heat source, the higher the heat transfer rate is at that area of the support structure. This may even out the heat pattern on the reception member.

FIG. 6 also illustrates of how the heat transfer may be controlled differently in different areas of the tool. In this example, the encircled area to the left in the figure, Area 1, has few pillars per area that are thin and therefore conducts less heat to the pulp-facing skin compared to the encircled area to the right in the figure, Area 2, which has more pillars per area that are thick.

Depending on the overall geometry of the tool (and consequently the paper product being produced), the gallery of pillars (more generally the support structure) may be optimized in each area of the tool to control the heat transfer in the best possible way. The intention may be to create a uniform heat pattern over the reception member 1 or to intentionally create areas on the reception member with higher temperatures. Thus, by controlling the position and dimension of the pillars, it is possible to control the heat transfer to the pulp-facing surface.

The support structure 2 may comprise one or more guiding walls arranged to conduct heat from the base member 3 to the reception member 1. The wall may be seen as a plurality of tightly arranged pillars, i.e., pillar that are joined together. FIG. 11 shows a portion of an example guiding wall. More specifically, this figure shows a top view of the wall where the base member would be arranged underneath and the reception member would be arranged above. In the figure, the portion of the wall has a constant thickness. The height (not shown in the figure) is also constant. The wall is arranged in a quasi-periodic pattern. Thus, the first and/or second contact surface is arranged in a non-uniform pattern so that a heat transfer of the support structure varies along the support structure. There may be a plurality of walls and the one or more walls may be arranged in different shapes, such as honeycomb.

The support structure 2 may comprise hexagonal walls, as illustrated in FIG. 12. This hexagonal support structure comprises a plurality of hexagonal prisms forming a honeycomb pattern. In FIG. 12, area 1201 illustrates an area with relatively thin hexagonal walls providing a low heat transfer rate. Area 1202 illustrates an area with thicker hexagonal walls relative to area 1201, which provide higher heat transfer rate compared to the walls of area 1201. Area 1203 illustrate an area with thicker hexagonal walls relative to area 1202, which provide higher heat transfer rate compared to the walls of area 1201 and area 1202. The wall thickness of the hexagonal support structure may vary in discrete areas as in the example of FIG. 12, or gradually change between different areas of the tool, e.g., in direction along the upper surface of the reception member.

The base member 3 may be provided with a first portion 6 configured to interface a source of heat 5. Furthermore, the base member may be all-solid from the surface facing the support structure to a flat backside, as is shown in the example tools of FIGS. 1, 6, and 8. Alternatively, the base member may be hollowed out, as is shown in the examples of FIG. 2-5 and 7. If the base member is hollowed out, it is preferably connected to a milled/machined backing member 4 to achieve a flat backside of the tool. In other words, the tool 100, 101 may further comprise a backing member 4 provided with a second portion 7 configured to interface a source of heat 5. In that case, the base member 3 is provided with a recess 8 in which the backing member is received. The recess may be arranged on the lower surface of the base member. FIG. 2 shows a schematic illustration of an example tool comprising the hollowed out base member 3. The backing member, however, is not shown in the figure for better visibility. The backing member is preferably made of a material with high thermal conductivity, such as a metal (e.g., steel, copper, brass, or aluminum). In the example tool 100 of FIGS. 3-5, the base member has been hollowed out such that it has a thickness about 3-10 mm measured in a normal direction on the surface facing the support structure.

FIG. 6 is a schematic illustration of heating elements placed on the backside of the tool. In this example, the backside of the tool is a flat side. The heating elements will provide heat through the base member and the support structure into the reception member. In other words, heat is generated on the flat backside of the tool by heating elements. The heat is conducted through the base member (optionally via the backing member) and through the pillars to the pulp-facing surface and the paper product.

The surface of the base member 3 (i.e. the surface facing the reception member) may be provided with at least one through hole 9 configured to evacuate a fluid when the wet-molded fiber product is received on the tool. This provides a large channel for evacuation of fluid. This through hole may extend to the lower surface of the base member. The backing member may also comprise channels for evacuation of fluid.

The tool 100, 101 may be manufactured using an additive manufacturing process, such as 3D printing. In particular, laser 3D printing may be used, or alternatively electron beam melting (EBM) or binder Jetting. Other examples include stereo-lithography, selective laser sintering, and fused filament fabrication (FFF), which is also called fused deposition modeling (FDM). In particular, any of the reception member 1, the support structure 2, and the base member 3 may be manufactured by an additive manufacturing process. These parts may be manufactured separately by an additive manufacturing process or in any combination.

It may be desired to only print complex geometries, which benefit from the printing process, and manufacture simpler geometries in other ways. In other words, print as little as possible to reduce cost. The mentioned recess for receiving the backing member is an example of a low-complexity part that does not need to be printed. The tools may have other recess/cutouts (with or without corresponding backing members) to reduce printing time.

The tool 100, 101 is preferably made of a material with high thermal conductivity, such as a metal (e.g., steel or aluminum). Preferably, the material is also suitable for the additive manufacturing process. The backing member may made of a different material than the rest of the tool. The material of the tool is also preferably corrosion resistant.

The base member 3, the reception member 1, and the support structure 2 may be monolithically formed. This provides good heat transfer properties of the tool. Such tool is also easy to manufacture, using e.g. an additive manufacturing process. Alternatively, the reception member and the support structure are monolithically formed, and the support structure is attached to base member. This way, only the reception member and the support structure may be manufactured using an additive manufacturing process, and the base member may be manufactured in other ways, e.g. using milling or casting. The reception member and the support structure are normally relative complex compared to the base member. Therefore, an additive manufacturing process may be the most efficient manufacturing process in terms of e.g. time and cost. Other manufacturing processes such as milling or casting may be more suitable for the base member, which has relatively low complexity. The support structure may e.g. be attached to the base member with thermally conductive adhesives, soldering or other processes.

According to some aspects, the base member and the support structure are monolithically formed, and the support structure is attached to reception member. According to further aspects, only the base member and the support structure are manufactured using an additive manufacturing process, and the reception member is manufactured by some other method.

According to some aspects, only one of the base member, the support structure, and the reception member is manufactured using an additive manufacturing process. According to some other aspects, the base member, the support structure, and the reception member are separately manufactured using an additive manufacturing process, and are thereafter attached to each other.

There is also disclosed herein an apparatus for thermoforming a wet-molded fiber product. The apparatus comprises a first tool 100 and a second tool 101 according to the discussions above, where the tools 100, 101 are configured to sandwich the wet-molded fiber product between the tools. The apparatus further comprises means for bringing the first tool 100 against the second tool 101, and a source of heat 5 arranged to heat the first tool 100 and/or the second tool 101. The apparatus may further comprise means for providing a suction force from the upper surface of the receiver member into the base member. Such means may comprise a vacuum pump.

The tool may comprise a 3D-printed metal structure built up in the following way: moving from the pulp-facing surface to the backside of the tool. Therefore, as is illustrated in FIG. 10, there is also disclosed herein a method for producing a tool 100, 101 according to the discussions above using an additive manufacturing process. The method comprises forming 810 the reception member 1, forming 820 the support structure 2 on the reception member 1, and forming 830 the base member 3 on the support structure 2. These steps may be performed in any order.

FIG. 10 schematically illustrates, in terms of a number of functional units, the components of a control unit 1000 according to embodiments of the discussions herein. This control unit 1000 may be comprised in an apparatus for additive manufacturing, such as a 3D-printer. Processing circuitry 1010 is provided using any combination of one or more of a suitable central processing unit CPU, multiprocessor, microcontroller, digital signal processor DSP, etc., capable of executing software instructions stored in a computer program product, e.g. in the form of a storage medium 1030. The processing circuitry 1010 may further be provided as at least one application specific integrated circuit (ASIC), or field programmable gate array (FPGA).

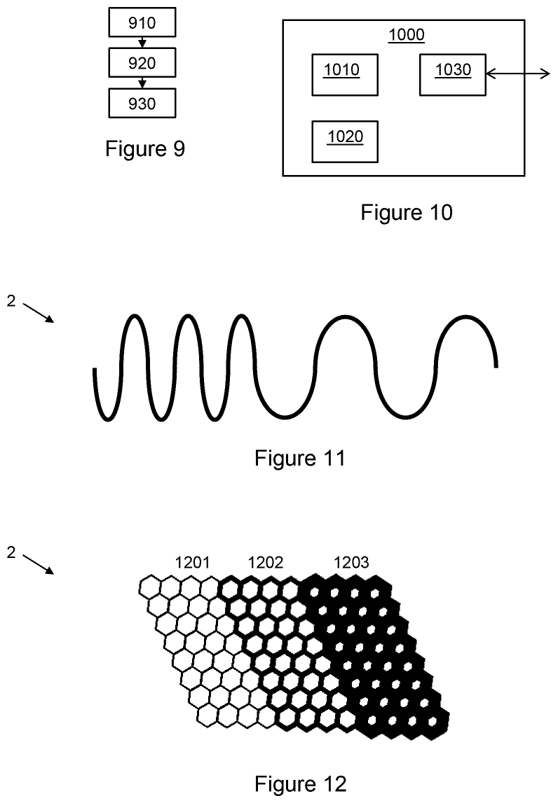

Particularly, the processing circuitry 1010 is configured to cause the control unit 1000 to perform a set of operations, or steps, such as the methods discussed in connection to FIG. 9. For example, the storage medium 1030 may store the set of operations, and the processing circuitry 1010 may be configured to retrieve the set of operations from the storage medium 1030 to cause the control unit 1000 to perform the set of operations. The set of operations may be provided as a set of executable instructions. Thus, the processing circuitry 1010 is thereby arranged to execute methods as herein disclosed.

The storage medium 1030 may also comprise persistent storage, which, for example, can be any single one or combination of magnetic memory, optical memory, solid-state memory or even remotely mounted memory.

The control unit 1000 may further comprise an interface 1020 for communications with at least one external device. As such, the interface 1020 may comprise one or more transmitters and receivers, comprising analogue and digital components and a suitable number of ports for wireline or wireless communication.

The processing circuitry 1010 controls the general operation of the control unit 1000, e.g., by sending data and control signals to the interface 1020 and the storage medium 1030, by receiving data and reports from the interface 1020, and by retrieving data and instructions from the storage medium 1030. Other components, as well as the related functionality, of the control node are omitted in order not to obscure the concepts presented herein.

There is also disclosed herein a computer readable medium carrying a computer program comprising program code means for performing the methods illustrated in FIG. 9, when said program product is run on a control unit. The computer readable medium and the code means may together form a computer program product.

1. A tool for thermoforming a wet-molded fiber product, the tool comprising:
a base member;
a reception member comprising an upper surface for receiving the wet-molded fiber product and a lower surface,
wherein the upper surface of the reception member comprises a complementary shape to the wet-molded fiber product, and
wherein the reception member is arranged to drain a fluid from a received wet-molded fiber product; and
a support structure providing a distance between a surface of the base member and the lower surface of the reception member, the support structure-being configured so that a heat transfer from the base member to the reception member through the support structure is controlled in a direction along the upper surface of the reception member.

2. The tool according to claim 1, wherein the reception member is provided with a plurality of through holes between the upper surface and the lower surface.

3. The tool according to claim 1, wherein at least a portion of the reception member is porous.

4. The tool according to claim 1, wherein the support structure is arranged in a non-uniform pattern in a direction along the lower surface of the reception member.

5. The tool according to claim 1, wherein the support structure comprises one or more guiding walls arranged to conduct heat from the base member to the reception member.

6. The tool according to claim 1, wherein the support structure comprises a plurality of pillars configured to conduct heat from the base member to the reception member.

7. The tool according to claim 6, wherein a number of pillars per area vary in a direction along the lower surface of the reception member.

8. The tool according to claim 6, wherein each pillar in the plurality of pillars is associated with a cross section, wherein respective cross sections of at least some of the plurality of pillars vary in a direction along the lower surface of the reception member.

9. The tool according to claim 1, wherein the base member, the reception member, and the support structure are monolithically formed.

10. The tool according to claim 1, wherein the reception member and the support structure are monolithically formed, and wherein the support structure is attached to the base member.

11. The tool according to claim 1, wherein the surface of the base member is provided with at least one through hole configured to evacuate a fluid when the wet-molded fiber product is received on the tool.

12. The tool according to claim 1, wherein the support structure comprises one or more paths configured to evacuate a fluid when the wet-molded fiber product is received on the tool.

13. The tool according to claim 1, wherein the base member is provided with a first portion configured to interface a source of heat.

14. The tool according to claim 1, further comprising a backing member provided with a second portion configured to interface a source of heat, wherein the base member is provided with a recess in which the backing member is received.

15. The tool according to claim 1, wherein the support structure is arranged to form one or more cavities between the reception member and the base member.

16. The tool according to claim 1, wherein at least one of the reception member, the support structure, or the base member is manufactured by an additive manufacturing process.

17. An apparatus for thermoforming a wet-molded fiber product, the apparatus comprising:
a first tool according to claim 1 and a second tool according to claim 1, wherein the first tool and the second tool are configured to sandwich the wet-molded fiber product between the first tool and the second tool;
means for bringing the first tool against the second tool; and
a source of heat configured to heat the first tool and/or the second tool.
